(19) United States
(12) Patent Application Publication
(10) Pub. No.: US 2014/0009962 A1
(43) Pub. Date: Jan. 9, 2014

(54) BACKLIGHT UNIT

(71) Applicant: SAMSUNG DISPLAY CO., LTD., YONGIN-CITY (KR)

(72) Inventors: EUI JEONG KANG, ASAN-SI (KR); YU DONG KIM, SUWON-SI (KR); HYUK HWAN KIM, HWASEONG-SI (KR); SEUNG IN BAEK, SEOUL (KR); YOUNG JUN SEO, SEOUL (KR)

(73) Assignee: SAMSUNG DISPLAY CO., LTD., YONGIN-CITY (KR)

(21) Appl. No.: 13/683,649

(22) Filed: Nov. 21, 2012

(30) Foreign Application Priority Data
Jul. 3, 2012 (KR) 10-2012-0072162

(51) Int. Cl. F21V 8/00

(52) U.S. Cl. CPC G02B 6/0011
USPC 362/612

(57) ABSTRACT

A backlight unit according to an exemplary embodiment of the present disclosure includes a light emitting diode with a substrate, a light emitting unit disposed on the substrate, and a mold frame disposed on the substrate that surrounds the light emitting unit, and a light guide adjacent to the light emitting diode. The light emitting diode includes a light emitting window defined by the mold frame from which light generated by the light emitting unit is emitted, the vertical height of the light emitting window is the same as the thickness of the light guide, and the maximum vertical height of the mold frame is greater than the thickness of the light guide.

### CROSS-REFERENCE TO RELATED APPLICATION

This application claims priority from Korean Patent Application No. 10-2012-0072162 filed in the Korean Intellectual Property Office on July 3, 2012, the contents of which are herein incorporated by reference in their entirety.

### BACKGROUND

(a) Technical Field

The present disclosure is directed to a backlight unit.

(b) Discussion of the Related Art

In general, a liquid crystal display (LCD) is a flat panel display that displays an image by adjusting a light transmittance ratio in response to an image signal. However, a liquid crystal display is not a self-emitting display capable of self-emitting light and thus requires a separate light source to provide light from a back side of a liquid crystal screen to visually display an image.

In this case, a liquid crystal display includes a power circuit for driving the light source, the light source itself, namely, a lamp to irradiate light from the rear side of a liquid crystal module to the front side of a liquid crystal panel and a backlight unit which is an integrally formed composite body for emitting uniform planar light.

Backlight units may be classified as either a direct type or an edge type according to a light-illuminating method, and recently, direct type and edge type flat panel backlights that employ a surface light source such as a light emitting diode (LED) have become more commonly used.

Here, in an edge type backlight unit, a light source is disposed on the side of the liquid crystal module, and light coming from the light source is configured to form planar light through a light guide.

Liquid crystal displays have become thinner and lighter in recent years, resulting in thinner light guides and smaller light emitting diodes. However, the smaller light emitting diodes tend to be hotter as a current capacity is increased for higher luminance.

### SUMMARY

Embodiments of the present disclosure are directed to a backlight unit that can reduce heat caused by the smaller light emitting diodes.

An exemplary embodiment of the present disclosure provides a backlight unit including: a light emitting diode including a substrate, a light emitting unit disposed on the substrate, and a mold frame disposed on the substrate surrounding the light emitting unit; and a light guide adjacent to the light emitting diode, wherein the light emitting diode includes a light emitting window corresponding to a boundary region in which light generated by the light emitting unit is deviates from the mold frame, the vertical height of the light emitting window is equal to the thickness of the light guide, and the maximum vertical height of the mold frame is greater than the thickness of the light guide.

The light emitted from the light emitting window may be incident through a side of the light guide.

A frame portion of the mold frame may include a horizontal section with a first width and a vertical section with a second width. The first width may differ from the second width.

The first width may be greater than the second width.

The first width may be less than the second width.

A frame portion of the mold frame may include a first horizontal section with the first width and a second horizontal section with the second width. The first width may differ from the second width.

The substrate and the mold frame may be integrally formed.

A maximum height y in the vertical direction of the mold frame and a height x of the light emitting window may satisfy

$$\frac{x}{15} \leq y \leq \frac{x}{4} \qquad Equation 1$$

The mold frame may be formed of polycyclohexylenedimethylene terephthalate (PCT) or an epoxy molding compound (EMC).

Another exemplary embodiment of the present disclosure provides a backlight unit that includes a light emitting diode including a substrate, a light emitting unit disposed on the substrate and a mold frame disposed on the substrate surrounding the light emitting unit, wherein the light emitting diode includes a light emitting window corresponding to a boundary region in which light generated by the light emitting unit is deviates from the mold frame, and a light guide that receives the light emitted through the light emitting window, wherein a maximum height y in a vertical direction of the mold frame and a height x of the light emitting window satisfy

$$\frac{x}{15} \leq y \leq \frac{x}{4} .$$

A vertical height of the light emitting window may equal a thickness of the light guide, and a maximum vertical height of the mold frame may be greater than the thickness of the light guide.

The light emitting diode may be disposed on one side of the light guide.

The backlight unit may further include a lead frame disposed on a lower surface for the substrate that dissipates heat generated by the light emitting diode.

A frame portion of the mold frame may include a horizontal section with a first width and a vertical section with a second width, wherein the first width may differ from the second width.

The first width may be greater than the second width.

The first width may be less than the second width.

A frame portion of the mold frame may include a first horizontal section with a first width and a second horizontal section with a second width, wherein the first width may differ from the second width.

The substrate and the mold frame may be integrally formed.

The mold frame may be formed of polycyclohexylenedimethylene terephthalate (PCT) or an epoxy molding compound (EMC).

According to the exemplary embodiment of the present disclosure, even though the light emitting window is reduced in size by increasing the width of the mold frame portion around the light emitting window, thermal resistance is not increased, thereby preventing the backlight unit lifespan from being reduced.

### BRIEF DESCRIPTION OF THE DRAWINGS

FIG. 1 is a cross-sectional view of a liquid crystal display including a backlight unit according to an exemplary embodiment of the present disclosure.

FIGS. 2 and 3 are top plan views of a light emitting diode of FIG. 1.

FIG. 4 is a top plan view of a light emitting diode according to an exemplary embodiment of the present disclosure.

FIG. 5 is a cross-sectional view taken along line V-V of FIG. 4.

FIG. 6 is a top plan view of a light emitting diode according to another exemplary embodiment of the present disclosure.

FIGS. 7 and 8 are top plan views of a light emitting diode according to another exemplary embodiment of the present disclosure.

### DETAILED DESCRIPTION OF EXEMPLARY EMBODIMENTS

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. Like reference numerals designate like elements throughout the specification.

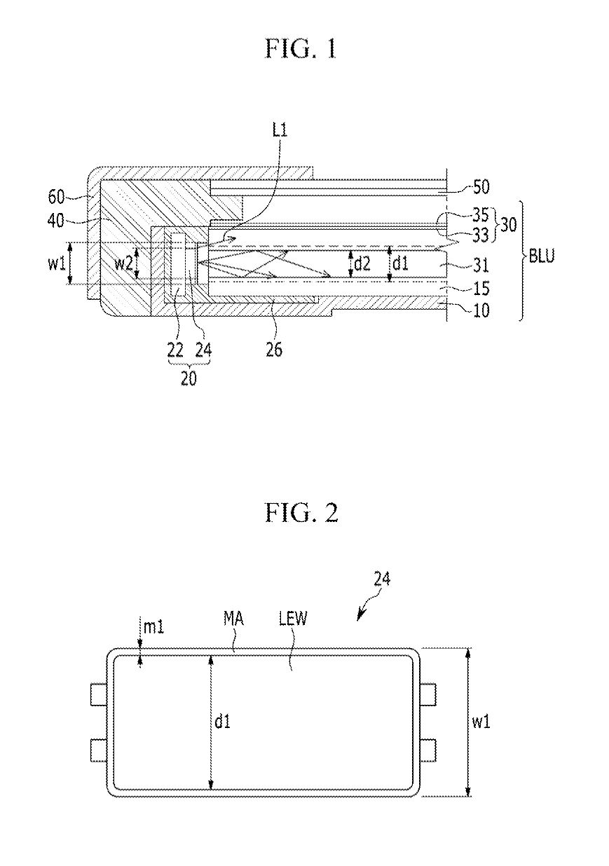

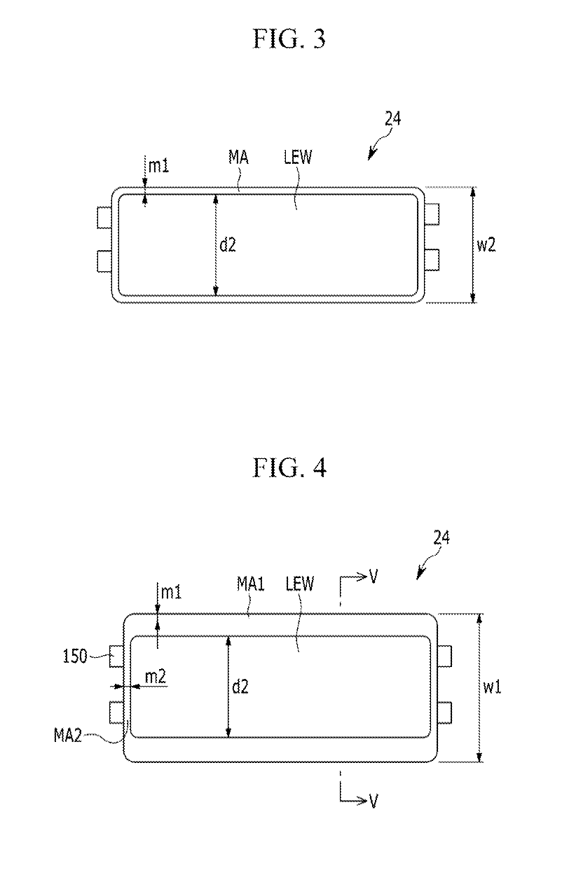

FIG. 1 is a cross-sectional view of a liquid crystal display including a backlight unit according to an exemplary embodiment of the present disclosure. FIGS. 2 and 3 are top plan views of a light emitting diode of FIG. 1.

A liquid crystal display including an edge type light emitting diode includes a backlight unit BLU and a liquid crystal panel 50 that displays an image. The backlight unit BLU includes a light source 20 provided on the bottom of one side of the liquid crystal panel 50 that provides light, a light guide 31 that guides light received from the light source 20 and an optical member 30 that includes a diffuser sheet 33 and a prism sheet 35 which improves optical characteristics of light propagating through the light guide 31.

Here, the light source 20 includes a plate 22 and a plurality of light emitting diodes 24. In this case, the light emitting diodes 24 may be installed to form an array on the plate 22 and are electrically connected to an external power supply. In addition, the plate 22 with the plurality of light emitting diodes 24 may be fixed within a light source cover 26, and in particular, the plate 22 may be vertically fixed to the top surface of a bottom cover 10 via a double-sided adhesive tape on the inner side of the light source cover 26.

The light guide 31 is provided on the bottom cover 10 to guide light received from the light emitting diode 24 of the light source 20 disposed on one side thereof and disperse the light throughout the top surface of the light guide 31. In this case, a reflector 15 disposed on the lower side of the light guide 31 increases light transmission efficiency.

The diffuser sheet 33 is disposed on the top surface of the light guide 31, and may uniformly diffuse the light propagating through the light guide 31. Further, the prism sheet 35 is disposed on the top surface of the diffuser sheet 33, and the prism sheet 35 guides light from the diffuser sheet 33 to a display area of the liquid crystal panel 50 where an image is displayed.

A square shaped main support 40 comprising a mold is fastened and provided on the upper side of the prism sheet 35. The liquid crystal panel 50 is provided on the main support 40. The liquid crystal panel 50 comprises a liquid crystal layer formed between a thin film transistor array panel and a corresponding upper substrate opposite to each other and bonded to maintain a uniform cell gap between the two substrates.

An upper cover 60 is fastened to the main support 40 and covers four side edge regions of the liquid crystal panel 50.

As light guides have become thinner, the light guide 31 may have a second thickness d2 that is thinner than a first thickness d1. As the light guide 31 becomes thinner, the height of the light emitting diode 24 with a first width w1 should be reduced to a second width w2. If the height of the light emitting diode 24 is maintained at the first width w1 while the thickness of the light guide 31 is reduced to the second thickness d2, some light may not propagate to the light guide 31, increasing an amount of light leakage, indicated by first light L1.

Therefore, the widths d1 and d2 of a light emitting window (LEW) may be substantially equal to the thickness of the light guide 31 as shown in FIGS. 2 and 3, and as the light guide 31 becomes thinner, the size of the light emitting diode 24 may be reduced to be smaller than the width of the light emitting window (LEW).

However, when the area of the light emitting window (LEW) is reduced as above, luminance is reduced, and thus a current applied to the light emitting diode may be increased to compensate for the reduced luminance. This increased current leads to more heat being generated by the light emitting diode.

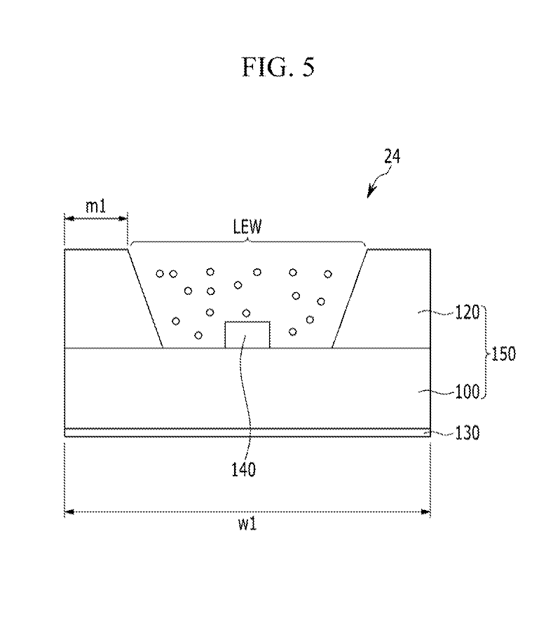

A backlight unit according to an exemplary embodiment of the present disclosure reduces heat generation by increasing the frame portion area of a mold frame surrounding a light emitting window even though the size of the light emitting window is reduced. Hereinafter, an exemplary embodiment of the present disclosure will be described in detail with reference to FIGS. 4 and 5.

FIG. 4 is a top plan view of a light emitting diode according to an exemplary embodiment of the present disclosure. FIG. 5 is a cross-sectional view taken along line V-V of FIG. 4.

With reference to FIGS. 1, 4 and 5, the backlight unit BLU according to a present exemplary embodiment includes a mold frame 120 formed on a substrate 100 along the outside thereof and a light emitting diode 24 including a light emitting unit 140 disposed on an exposed portion of substrate 100 surrounded by the mold frame 120. The substrate 100 and the mold frame 120 form a package 150 that can protect the light emitting unit 140 from outside humidity.

In a present exemplary embodiment, a light emitting window (LEW) is a region surrounded by the mold frame 120. Specifically, the light emitting window may be defined as a corresponding side to a boundary region wherein light generated by the light emitting unit 140 devites from the mold frame 120. The frame portion of the mold frame 120 defining the light emitting window (LEW) includes a horizontal section MA1 with a first width m1 and a vertical section MA2 with a second width m2. As shown in FIG. 4, the horizontal section MA1 extends along a lengthwise direction of the light guide 31, and the vertical section MA2 extends along the thickness direction of the light guide 31.

In a present exemplary embodiment, the first width m1 of the horizontal section MA1 is greater than the second width m2 of the vertical section MA2. As the thickness of the light guide 31 is reduced to a second thickness d2, the height of the light emitting window (LEW) is also reduced to be substantially equal to the thickness of the light guide 31, but the width m1 of the horizontal section MA1 of the mold frame 120 is increased relative to the width m2 of the vertical section MA2.

A lead frame 130 is disposed on the lower surface of the substrate 100. Because the lead frame 130 may radiate heat generated by the light emitting diode 24, the area reduction may cause more heat to be generated. In a present exemplary embodiment, since the contact area of the substrate 100 with the lead frame 130 is maintained constant while the size of the light emitting window (LEW) is reduced, heat may be adequately dissipated despite the thickness reduction. This results from increasing the frame portion width m1 of the mold frame 120 that defines the light emitting window (LEW).

If a maximum vertical height of the mold frame 120 in FIG. 4 is y and a height of the light emitting window (LEW) is x, Equation 1 below may be satisfied.

$$\frac{x}{15} \leq y \leq \frac{x}{4} \qquad Equation 1$$

The substrate 100 and the mold frame 120 in a present exemplary embodiment may be integrally formed through an injection molding, using polycyclohexylenedimethylene terephthalate (PCT) or an epoxy molding compound (EMC) as a material.

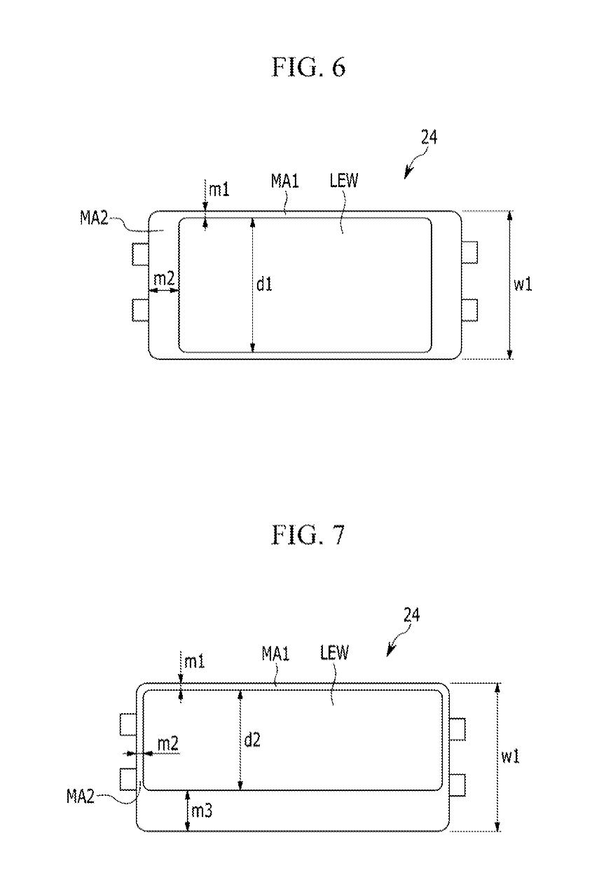

FIG. 6 is a top plan view of a light emitting diode according to another exemplary embodiment of the present disclosure.

Referring to FIG. 6, the frame portion of a mold frame 120 includes a horizontal section MA1 with a first width m1 and a vertical section MA2 with a second width m2. As shown in FIG. 6, the horizontal section MA1 extends along a lengthwise direction, and the vertical section MA2 extends along the thickness direction of the light guide 31. In contrast to an exemplary embodiment of FIG. 4, in a present exemplary embodiment, the first width m1 of the horizontal section MA1 is less than the second width m2 of the vertical section MA2.

If a long axis in the horizontal direction of a light emitting diode 24 is increased to increase the amount of light or to mount two light emitting chips within the mold frame 120, color difference may occur between a central portion and a side portion of a light emitting window (LEW). In a present exemplary embodiment, color balance due to this color difference may be improved by reducing the long axis of the light emitting window (LEW).

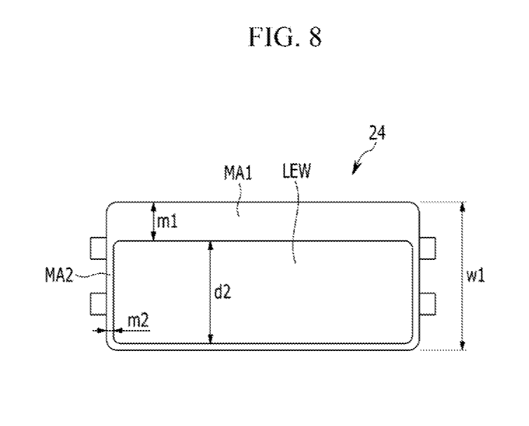

FIGS. 7 and 8 are top plan views of a light emitting diode according to another exemplary embodiment of the present disclosure.

Referring to FIGS. 7 and 8, a light emitting window (LEW) is asymmetrically positioned in a plane defined by the edges of a mold frame 120. In other words, in FIG. 7, the light emitting window (LEW) is positioned on an upper side of the mold frame 120 plane, and in FIG. 8, the light emitting window (LEW) is positioned on a lower side of the mold frame 120 plane. In particular, the frame portion of the mold frame 120 defining the light emitting window (LEW) includes a first horizontal section MA1 with a first width m1 and a second horizontal section MA2 with a second width m2, and the size of the first width m1 is different from that of the second width m2.

It may be challenging to align a light guide 31 with a thin light emitting diode 24, and a central position may be randomly adjusted to reduce phenomena such as light leakage, but in a present exemplary embodiment, the central position may be adjusted to maintain thermal resistance by maintaining the area of a lead frame through an asymmetrical light emitting window (LEW).

While this disclosure has been described in connection with what is presently considered to be practical exemplary embodiments, it is to be understood that the present disclosure is not limited to the disclosed embodiments, but, on the contrary, is intended to cover various modifications and equivalent arrangements included within the spirit and scope of the appended claims.

What is claimed is:

1. A backlight unit comprising:
a light emitting diode including a substrate, a light emitting unit disposed on the substrate and a mold frame disposed on the substrate surrounding the light emitting unit; and
a light guide adjacent to the light emitting diode,
wherein the light emitting diode includes a light emitting window corresponding to a boundary region in which light generated by the light emitting unit is deviates from the mold frame, and
a vertical height of the light emitting window is equal to a thickness of the light guide, and a maximum vertical height of the mold frame is greater than the thickness of the light guide.

2. The backlight unit of claim 1, wherein:
light emitted from the light emitting window is incident through a side of the light guide.

3. The backlight unit of claim 1, wherein:
a frame portion of the mold frame includes a horizontal section with a first width and a vertical section with a second width, wherein the first width is different from the second width.

4. The backlight unit of claim 3, wherein:
the first width is greater than the second width.

5. The backlight unit of claim 3, wherein:
the first width is less than the second width.

6. The backlight unit of claim 1, wherein:
a frame portion of the mold frame includes a first horizontal section with a first width and a second horizontal section with a second width, wherein the first width is different from the second width.

7. The backlight unit of claim 1, wherein:
the substrate and the mold frame are integrally formed.

8. The backlight unit of claim 1, wherein:
a maximum height y in the vertical direction of the mold frame and a height x of the light emitting window satisfy
$$\frac{x}{15} \leq y \leq \frac{x}{4} .$$

9. The backlight unit of claim 1, wherein:
the mold frame is formed of polycyclohexylenedimethylene terephthalate (PCT) or an epoxy molding compound (EMC).

10. A backlight unit comprising:
a light emitting diode including a substrate, a light emitting unit disposed on the substrate and a mold frame disposed on the substrate surrounding the light emitting unit, wherein the light emitting diode includes a light emitting window corresponding to a boundary region in which light generated by the light emitting unit is deviates from the mold frame; and
a light guide that receives the light emitted through the light emitting window, wherein a maximum height y in a vertical direction of the mold frame and a height x of the light emitting window satisfy
$$\frac{x}{15} \leq y \leq \frac{x}{4} .$$

11. The backlight unit of claim 10, wherein a vertical height of the light emitting window is equal to a thickness of the light guide, and a maximum vertical height of the mold frame is greater than the thickness of the light guide.

12. The backlight unit of claim 10, wherein the light emitting diode is disposed on one side of the light guide.

13. The backlight unit of claim 10, further comprising a lead frame disposed on a lower surface for the substrate that dissipates heat generated by the light emitting diode.

14. The backlight unit of claim 10, wherein:
a frame portion of the mold frame includes a horizontal section with a first width and a vertical section with a second width, wherein the first width differs from the second width.

15. The backlight unit of claim 14, wherein:
the first width is greater than the second width.

16. The backlight unit of claim 14, wherein:
the first width is less than the second width.

17. The backlight unit of claim 10, wherein:
a frame portion of the mold frame includes a first horizontal section with a first width and a second horizontal section with a second width, wherein the first width differs from the second width.

18. The backlight unit of claim 10, wherein:
the substrate and the mold frame are integrally formed.

19. The backlight unit of claim 10, wherein:
the mold frame is formed of polycyclohexylenedimethylene terephthalate (PCT) or an epoxy molding compound (EMC).
